(19) United States
(12) Patent Application Publication
(10) Pub. No.: US 2022/0403700 A1
(43) Pub. Date: Dec. 22, 2022

(54) REPAIR SHEET FOR MOSQUITO WINDOW SCREEN AND MANUFACTURING DEVICE THEREFOR

(71) Applicant: Ilbyoung Yi, Seoul (KR)

(72) Inventor: Ilbyoung Yi, Seoul (KR)

(21) Appl. No.: 17/647,960

(22) Filed: Jan. 13, 2022

(30) Foreign Application Priority Data
Jun. 22, 2021 (KR) 10-2021-0080745

(51) Int. Cl. E06B 9/52; C09J 7/20; C09J 7/40; C09J 5/06

(52) U.S. Cl. CPC E06B 9/52; C09J 7/203; C09J 7/403; C09J 5/06; C09J 2301/204; C09J 2301/18; E06B 2009/525

(57) ABSTRACT

Provided is a repair sheet for a mosquito window screen, including: a grid sheet (100); an adhesive layer (120) provided on the grid sheet (100); and a release liner (140) provided on the adhesive layer (120), wherein through-holes (110) are formed through the grid sheet (100) and the adhesive layer (120), wherein the release liner (140) is provided over the adhesive layer (120) and serves for a user to cut the repair sheet in a desired size and shape.

### FIELD OF INVENTION

The present invention relates to a repair sheet for a mosquito window screen and a device for manufacturing it. More particularly, it relates to a repair sheet for a mosquito window screen and a device for manufacturing it that can secure air permeability while maximizing adhesion to a damaged mosquito window screen. The mosquito window screen can be tailored in a size and in a shape as desired by a user.

### BACKGROUND OF INVENTION

In general, the mosquito window screen is a dense net made of a synthetic resin, of thin wires, of metal such as aluminum, etc. It is installed on windows and doors to block insects such as mosquitoes and flies from entering indoors while maintaining ventilation.

Over time, a mosquito window screen wears and tears due to rain and snow, or gets a hole or tears due to children's mischief and negligent handling. Various products are in the market to repair such damaged mosquito window screen. One example is the published patent No. 20-2010-0003529. This reference discloses a mosquito window screen repair sheet. FIG. 1 shows the mosquito window screen repair sheet which includes a repair net (10) and a double-bonded tape (12). The double-bonded tape (12) is provided along a boundary of the repair net (10) in a strip shape and covered with a release liner (11). In use, the release liner (11) is removed to expose the double-bonded tape (12). Then, the exposed double-bonded tape (12) is placed and bonded to a damaged region (k) of a mosquito window screen (13).

According to the above-mentioned conventional repair sheet, the adhesion is supported only by the double-bonded tape (12). Adhesive strength is weak since the double-bonded tape (12) is provided to a limited area, i.e., only along an outer boundary of the repair net (10). In addition, the repair sheet is in a fixed shape and thus it is hard for a user to cut or tailor the repair sheet in a size or in a shape as desired. The adhesive region is limited to where the double-bonded tape (12) is provided, i.e., only along an outer boundary of the repair net (10), the repair sheet tends to be easily separated from the damaged mosquito window screen (13). Thus, frequent replacement is necessary.

### SUMMARY OF INVENTION

The present invention is presented to solve such problems. According to the present invention, a grid sheet is provided which includes a center region and a boundary region. An adhesive layer is provided over the grid sheet. Through-holes are formed in the center region and arranged in a net shape. An adhesive sheet is provided over the grid sheet in the boundary region. Unlike the conventional repair sheet, the adhesive layer is provided not only in the boundary region but also in the center region of the grid sheet. Thus, adhesive strength is enhanced while maintaining air permeability.

The adhesive sheet can be formed thin and flexible. A release liner is provided over the adhesive sheet. Optionally, a guideline is provided on the release liner so that the repair sheet can be cut and tailored in such a size and shape as desired by a user.

The present invention provides a repair sheet for a mosquito window screen, comprising: a grid sheet (100); an adhesive layer (120) provided on the grid sheet (100); and a release liner (140) provided on the adhesive layer (120), wherein through-holes (110) are formed through the grid sheet (100) and the adhesive layer (120), wherein the release liner (140) is provided over the adhesive layer (120) and serves for a user to cut the repair sheet in a desired size and shape.

According to an embodiment of the present invention, the adhesive layer (120) does not fill in the through-holes. So, air permeability is maintained while adhesive strength is enhanced. The grid sheet (100) includes a center region and a boundary region. The through-holes (110) are formed in the center region, but not in the boundary region. The adhesive layer (120) is provided both in the center region and in the boundary region.

According to an embodiment of the present invention, the repair sheet may further includes an adhesive sheet (130). The adhesive sheet (130) is provided in the boundary region and between the adhesive layer (120) and release liner (140). The adhesive sheet (130) is supposed to be bonded to a damaged mosquito window screen. According to an embodiment of the present invention, the through-holes (110) are formed in the center region but not in the boundary region. The adhesive layer (120) is provided both in the center region and in the boundary region.

According to an embodiment of the present invention, the release liner (140) includes a first release liner (142) and a second release liner (144). The first release liner (142) is provided over the through-holes (110) and the adhesive layer (120) in the center region. The second release liner (144) is provided over grid sheet (100) in the boundary regions. A guideline (150), which serves as a cutting line, is provided on the first and second release liners (142, 144). In another embodiment, the guideline (150) is omitted.

The present invention provides a device for manufacturing a repair sheet for a mosquito window screen, including: a first winding roller (202); an adhesive supply unit (210); a heating unit (230); a release liner feeding unit (240); a release liner adhering unit (250); and a second winding roller (204), wherein a grid sheet (100) is wound around the first winding roller (202), wherein the adhesive supply unit (210) deposits an adhesive onto the grid sheet and including a deposition roller (220), wherein the heating unit (230) applies heat to the adhesive on the grid sheet (100), wherein the release liner feeding unit (240) supplies a release liner onto the grid sheet (100), wherein the release liner adhering unit (250) bonds the release liner to the grid sheet (100) to form a repair sheet, and wherein the second winding roller (204) winds up the repair sheet. The device further includes: an adhesive sheet feeding unit (240) which supplies an adhesive sheet (130) to over the grid sheet (100); and a sheet adhering unit (250) which adheres the adhesive sheet (130) onto the grid sheet (100).

A deposition prevention pattern (224) is provided on a deposition surface (222) of the deposition roller (220). Through-holes (110) are provided on the grid sheet (100). The deposition roller (220) rotates while the deposition surface (222) is in contact with the adhesive to carry the adhesive onto the grid sheet (100). The deposition prevention pattern (224) may include (i) grooves, (ii) protrusions, or (iii) a combination thereof. The grooves or the protrusions are arranged in a manner of corresponding to the through-holes (110) and prevents the adhesive from being deposited in the through-holes (110).

### ADVANTAGES OF INVENTION

According to an embodiment of the present invention, the adhesive sheet (130) is provided in the boundary region. The adhesive layer (120) is provided in the center region. Under this structure, adhesion strength between the repair sheet and a damaged mosquito window screen is enhanced while maintaining air permeability.

In addition, according to an embodiment of the present invention, the adhesive sheet (130) may be formed thin and flexible. A release liner (140) is provided over the adhesive sheet (130). Optionally, a guideline (150) is provided over the release liner (140). The repair sheet can be cut or tailed in a desired size and shape using the guideline (150).

### BRIEF DESCRIPTION OF DRAWINGS

FIG. 1 shows a repair sheet for a mosquito window screen according to prior art.

FIG. 2 and FIG. 3 show a repair sheet for a mosquito window screen according to an embodiment of the present invention.

FIG. 4 shows a device for manufacturing a repair sheet for a mosquito window screen according to an embodiment of the present invention.

FIG. 5 shows an adhesive deposition roller according to an embodiment of the present invention which is employed in a device for manufacturing a repair sheet for a mosquito window screen

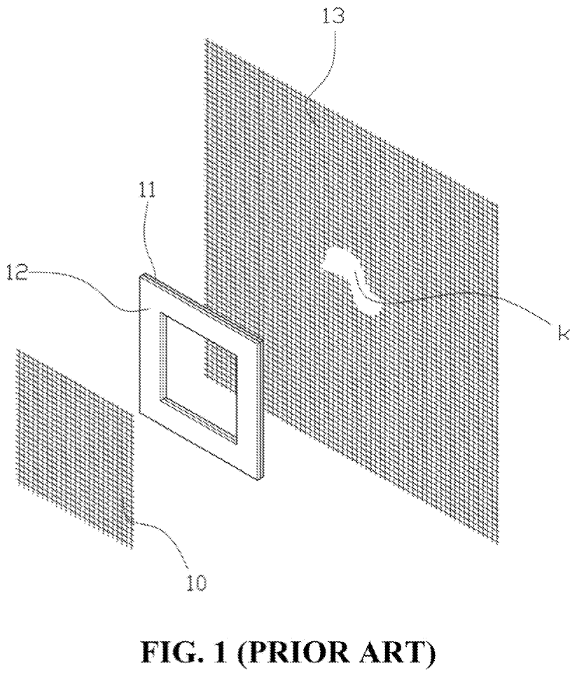

### DETAILED DESCRIPTION

Hereinafter, embodiments of the present invention will be described in detail with reference to the accompanying drawings.

A repair sheet according to the present invention includes: a grid sheet (100); an adhesive layer (120) provided on the grid sheet (100); and a release liner (140) provided on the adhesive layer (120). Through-holes (110) are formed through the grid sheet (100) and the adhesive layer (120). The release liner (140) is provided over the adhesive layer (120) and serves for a user to cut the repair sheet in a desired size and shape.

The repair sheet according to the present invention may be manufactured using a device which will be described later. The repair sheet includes: a grid sheet (100); an adhesive layer (120) provided on the grid sheet (100); and adhesive sheet (130) provided on the adhesive layer (120). Through-holes (110) are formed through the grid sheet (100) and the adhesive layer (120). The through-holes (110) are spaced from each other and arranged in a uniform manner.

Here, the grid sheet (100) may be made of a metal, or may be made of a synthetic resin. In addition, the through holes (110) may be in a square shape. The adhesive layer (120) is formed on the grid sheet (100), but not in the through holes (110). The shape of the grid sheet (100) is not limited to the square shape. It can be in various shapes such as a circle or a polygon.

An adhesive is applied on the grid sheet (100) using a deposition roller (220) to form the adhesive layer (120). Preferably, the adhesive does not fill in the through holes (110). That is, the adhesive is applied onto the grid sheet (100), but not in the through holes (110).

The repair sheet of the present invention can be more securely attached to a damaged mosquito window screen by the adhesive layer (120) which is provided on the entire surface of the grid sheet (100). Thus, tight adhesion between the repair sheet and the damaged mosquito window screen can be secured and lasts for a long time, thus preventing the repair sheet from being easily separated from the damaged mosquito window screen. According to the present invention, the grid sheet can be made of wires. The wires are interwoven perpendicularly to form a mesh structure. As the result, a number of through holes (110) are formed.

According to the present invention, the adhesive sheet (130) is provided over the grid sheet (100) in the boundary region. The adhesive layer (120) is formed on the grid sheet (100) in the boundary region. Then, the adhesive sheet (130) is formed on the adhesive layer (120) in the boundary region.

In addition, a release liner (140) may be further provided over the grid sheet (100). The release liner (140) protects the adhesive layer (120) and/or the adhesive sheet (130). The guideline (150) is provided on the release liner (140). The guideline (150) can help a user cut the repair sheet in a uniform size. Repeatedly, the guideline (150) is optional.

Here, the release liner (140) includes a first release liner (142) and a second release liner (144). The first release liner (142) is provided over the through-holes (110) and the adhesive layer (120) in the center region. The second release liner (144) is provided over the adhesive sheet (130) in the boundary region.

In an embodiment, the first and the second release liners (142, 144) may be integrated into a single liner, but is not limited thereto. In another embodiment, the first and the second release liners (142, 144) may be provided in separate sheets so as to individually cover the adhesive layer (120) in the center region and the adhesive sheet (130) in the boundary region.

Each of the first and second release liners (142 and 144) may be in a stripe shape extending in a direction in which the repair sheet extends. Optionally, a guideline (150) may be further provided which serves as a cutting line. A user may cut the repair sheet in a uniform width using the guideline (150). Since the guideline (150) is optional, the release liner (140) may be formed without the guideline (150).

The function of the guideline (150) is not limited to guide a user to cut the repair sheet in such a size and shape as desired. The guideline (150) may also be useful in a manufacturing process. Specifically, the repair sheet can be cut in a uniform size using the guideline (150). Without the guideline (150), it is difficult to precisely cut the repair sheet in a desired size in a manufacturing process. Without the guideline (150), the repair sheet may be cut with a narrow adhesive sheet at one boundary region and with a broader adhesive sheet (130) at another boundary region. A logo, a user-desired text, picture, number, etc., can be printed on the first release liner (142). However, it not necessarily required and can be omitted.

The repair sheet with a given length is wound for storage. For example, the repair sheet is wound around a second winding roller (204) for storage. In use, the repair sheet is released from the second winding roller (204) and cut in a wanted length by a user.

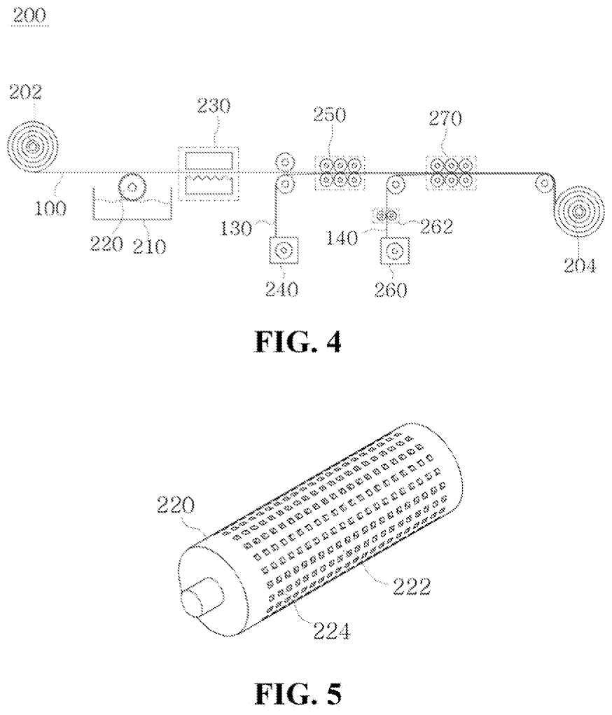

As shown in FIGS. 4 and 5, a device for manufacturing a repair sheet (200) of the present invention includes: a first winding roller (202); an adhesive supply unit (210); a heating unit (230); an adhesive sheet feeding unit (240); a sheet adhering unit (250); a release liner feeding unit (260); and a release liner adhering unit (270). The grid sheet (100) is wound around the first winding roller (202). The adhesive supply unit (210) deposits an adhesive onto the grid sheet and including a deposition roller (220). The heating unit (230) applies heat to the adhesive on the grid sheet (100) to form an adhesive layer (120). The adhesive sheet feeding unit (240) which supplies an adhesive sheet (130) to over the grid sheet (100). The sheet adhering unit (250) which bonds the adhesive sheet (130) over the grid sheet (100). The release liner feeding unit (260) supplies a release liner over the grid sheet (100). The release liner adhering unit (270) bonds the release liner to the grid sheet (100) to form a repair sheet.

A deposition prevention pattern (224) is provided on a deposition surface (222) of the deposition roller (220). Through-holes (110) are provided on the grid sheet (100). The deposition roller (220) rotates while the deposition surface (222) is in contact with the adhesive to carry the adhesive onto the grid sheet (100). The deposition prevention pattern (224) may include (i) grooves, (ii) protrusions, or (iii) a combination thereof. The grooves or the protrusions are arranged in a manner of corresponding to the through-holes (110) and prevents the adhesive from being deposited in the through-holes (110).

The grooves or the protrusions may be formed in the same number as the number of the through-holes (110). The distance between neighboring grooves or the protrusions may correspond to the distance between neighboring through-holes (110). In the above-mentioned embodiment, the number of the deposition roller (220) is one. However, the number is not limited thereto. Rather, the number may be two or more and adjusted depending on the size or shape of the repair sheet.

In addition, as shown in the drawings, the adhesive is deposited over the grid sheet (100) but not in the through holes (110) using the deposition roller (220). Since the grooves or the protrusions forming of the deposition prevention pattern (224) are provided on the deposition roller (220) and arranged in the manner of corresponding to the through holes (110), the adhesive is not applied to the through holes (110) when the deposition roller (220) is used.

Meanwhile, a drying unit may be further provided between the adhesive supply unit (210) and the heating unit (230) for drying the adhesive. Upon drying, the adhesive forms an adhesive region. The structure of the drying unit is not specifically limited.

The adhesive is deposited on a back boundary (or a lower boundary) of the grid sheet (100). The heating unit (230) applies heat to the adhesive on the grid sheet (100) to form the adhesive layer (120). The adhesive layer (120) enhances adhesion strength between the grid sheet (100) and the adhesive sheet (130). The structure of the heating unit (230) is not specifically limited. A conventional heater can serve as the heating unit (230).

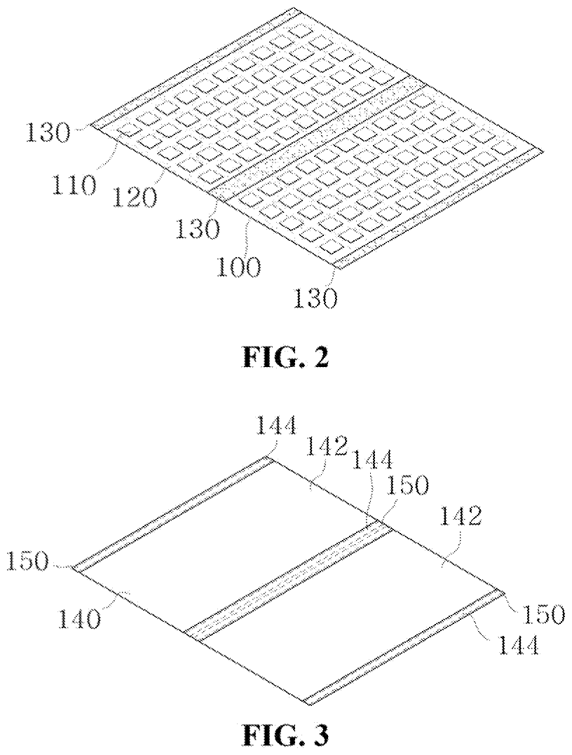

The adhesive sheet (130) is released from the sheet feeding unit (240), provided to over the grid sheet (100), and then bonded to the adhesive layer (120). The sheet feeding unit (240) may feed separate adhesive sheets to over a first boundary region and a second boundary region of the grid sheet (100), respectively. Two or more unit of the grid sheet (100) may be arranged side by side. See FIG. 3. The first boundary region may be defined as a boundary region which has a neighboring grid sheet (100). In contrast, the second boundary region may be defined as a boundary region which has no neighboring grid sheet (100). For example, the sheet feeding unit (240) includes a first sheet feeding unit and a second sheet feeding unit. The first sheet feeding unit (240) feeds a first adhesive sheet (130) over the first boundary region. The second sheet feeding unit (240) feeds a second adhesive sheet (130) over the second boundary region.

According to another embodiment of the present invention, the release liner (140) can be directly attached to the adhesive layer (120), rather than interposing the adhesive sheet (130) between the adhesive layer (120) and the release liner (140). In this case, the device for manufacturing a repair sheet can be configured without the sheet feeding unit (240).

The sheet adhering unit (250) may include a number of pressure rollers which bond the first and the second adhesive sheets (130) to the first and the second boundary regions, respectively.

The release liner feeding unit (260) feeds a release liner (140) to over grid sheet (100) via a pattern forming unit (262). The pattern forming unit (262) forms a guideline (150) on the release liner (140).

Then, the release liner is forwarded to the release liner adhering unit (270). The release liner adhering unit (270) bonds the release liner (140) onto the adhesive sheet (130) and/or onto the adhesive layer (120). In a preferred embodiment, the release liner feeding unit (260) includes a first release liner feeding unit and a second release liner feeding unit which supply a first release liner (142) and a second release liner (144), respectively. The first release liner (142) is provided and bonded to the center region. The second release liner (144) is provided and bonded to the boundary region.

The release liner adhering unit (270) includes a number of pressure rollers which press the first and the second release liners (142, 144), respectively, over the adhesive layer (120) in the center region and over the adhesive sheet (130) in the boundary region. Accordingly, a repair sheet is produced. The second winding roller (204) is further provided to wind up the repair sheet produced as such.

### REFERENCE NUMBERS

100: grid sheet
110: through-holes
120: adhesive layer
130: adhesive sheet
140: release liner
142: first release liner
144: second release liner
150: guideline
200: device for manufacturing a repair sheet
202: first winding roller
204: second winding roller
210: adhesive supply unit
220: deposition roller
224: deposition prevention pattern
230: heating unit
240: adhesive sheet feeding unit
250: sheet adhering unit
260: release liner feeding unit
270: release liner adhering unit

What is claimed is:

1. A repair sheet for a mosquito window screen, comprising:
a grid sheet (100); an adhesive layer (120) provided on the grid sheet (100); and a release liner (140) provided on the adhesive layer (120),
wherein through-holes (110) are formed through the grid sheet (100) and the adhesive layer (120),
wherein the release liner (140) is provided over the adhesive layer (120).

2. The repair sheet according to claim 1,
wherein the adhesive layer (120) is not provided in the through-holes (110).

3. The repair sheet according to claim 1,
wherein the grid sheet (100) includes a center region and a boundary region,
wherein the through-holes (110) are formed in the center region, but not in the boundary region,
wherein the adhesive layer (120) is provided both in the center region and in the boundary region.

4. The repair sheet according to claim 3, further comprising:
an adhesive sheet (130) provided in the boundary region and between the adhesive layer (120) and the release liner (140),
wherein the adhesive sheet (130) serves to be bonded to a damaged mosquito window screen.

5. The repair sheet according to claim 4,
wherein the release liner (140) includes a first release liner (142) and a second release liner (144),
wherein the first release liner (142) is provided over the through-holes (110) and the adhesive layer (120) in the center region,
wherein the second release liner (144) is provided over the adhesive sheet (130) in the boundary region,
wherein a guideline (150), which serves as a cutting line, is provided on the first and second release liners (142, 144).

6. A device for manufacturing a repair sheet for a mosquito window screen, comprising:
a first winding roller (202); an adhesive supply unit (210); a heating unit (230); a release liner feeding unit (260); a release liner adhering unit (270); and a second winding roller (204),
wherein a grid sheet (100) is wound around the first winding roller (202),
wherein the adhesive supply unit (210) deposits an adhesive onto the grid sheet and including a deposition roller (220),
wherein the heating unit (230) applies heat to the adhesive on the grid sheet (100),
wherein the release liner feeding unit (260) supplies a release liner to over the grid sheet (100),
wherein the release liner adhering unit (270) bonds the release liner to over the grid sheet (100) to form a repair sheet, and
wherein the second winding roller (204) winds up the repair sheet.

7. The device according to claim 6,
wherein a deposition prevention pattern (224) is provided on a deposition surface (222) of the deposition roller (220),
wherein through-holes (110) are provided on the grid sheet (100),
wherein the deposition roller (220) rotates while the deposition surface (222) is in contact with the adhesive to carry the adhesive onto the grid sheet (100),
wherein the deposition prevention pattern (224) includes (i) grooves, (ii) protrusions, or (iii) a combination thereof,
wherein the grooves or the protrusions are arranged in a manner of corresponding to the through-holes (110) and prevents the adhesive from being deposited in the through-holes (110).

8. The device according to claim 6, further comprising:
an adhesive sheet feeding unit (240) which feeds an adhesive sheet (130) to over the grid sheet (100); and
a sheet adhering unit (250) which adheres the adhesive sheet (130) to over the grid sheet (100).
